(19) United States
(12) Patent Application Publication
(10) Pub. No.: US 2025/0005733 A1
(43) Pub. Date: Jan. 2, 2025

(54) SYSTEMS AND PROCESSES FOR DETECTION, SEGMENTATION, AND CLASSIFICATION OF POULTRY CARCASS PARTS AND DEFECTS

(71) Applicant: BOARD OF TRUSTEES OF THE UNIVERSITY OF ARKANSAS, Little Rock, AR (US)

(72) Inventors: Michael T. Kidd, Springdale, AR (US); Thi Hoang Ngan Le, Fayetteville, AR (US)

(73) Assignee: BOARD OF TRUSTEES OF THE UNIVERSITY OF ARKANSAS, Little Rock, AR (US)

(21) Appl. No.: 18/689,373

(22) PCT Filed: Sep. 13, 2022
(86) PCT No.: PCT/US2022/076377

§ 371 Date: Mar. 5, 2024

Related U.S. Application Data
(60) Provisional application No. 63/243,247, filed on Sep. 13, 2021.

(51) Int. Cl. G06T 7/00; G06T 7/50; G06V 10/25; G06V 10/26; G06V 10/764; G06V 10/77; G06V 10/82; G06V 10/94; G06V 20/40; G06V 20/50

(52) U.S. Cl. CPC G06T 7/0004; G06T 7/50; G06V 10/25; G06V 10/26; G06V 10/764; G06V 10/7715; G06V 10/82; G06V 10/95; G06V 20/41; G06V 20/50; G06T 2207/10016; G06T 2207/20084; G06T 2207/20132; G06T 2207/30128; G06V 2201/06

(57) ABSTRACT

This invention generally relates to a system and process for implementing computer vision and machine learning in a poultry processing plant. In one mode of operation, the invention is configured to analyze images of processed poultry moved by a conveyor to automatically determine if the poultry carcasses have any defects. In another mode of operation, the system is configured to analyze images of processed poultry parts being weighed on a scale. In this mode of operation, the system is configured to automatically classify the poultry carcass part being weighed.

### CROSS-REFERENCE TO RELATED APPLICATIONS

This application claims the benefit of U.S. Provisional Patent Application No. 63/243,247 filed on Sep. 13, 2021, and incorporates said provisional application by reference in its entirety into this document as if fully set out at this point.

### BACKGROUND OF THE INVENTION

### 1. Field of the Invention

This invention generally relates to systems and processes for detecting, segmenting, and classifying poultry carcasses using machine learning and computer vision in a smart-automated poultry plant.

### 2. Description of the Related Art

Numerous studies have demonstrated increasing annual poultry consummation rates, mainly due to relatively low prices, nutritional value, and health benefits. With annualized increases in broiler production, concomitant increases in labor are necessary for meat production supply chain efficiency. Conventional chicken processing plants rely heavily on manual labor throughout the hanging, processing, deboning, and packaging of components at the plant. Employees are involved in visually inspecting chickens, weighing carcasses, and determining the size and weight of chicken parts. The reliance on human labor is expensive and prone to error. In addition to the costs of increased workforce labor and workforce development, many poultry companies are suffering from labor shortages.

Another negative side of relying on human labor for poultry processing is the varying results of carcass evaluation consistency. Many companies use assembly lines stationed by employees to inspect the quality of chicken carcasses, which leaves room for human error and can result in miscategorized carcass defections. For example, after the first stage of broiler processing, i.e., evisceration, not every chicken is a quality carcass. Imperfections may arise due to the stunner, scalder, picker, and evisceration processes, and detecting these imperfections can be challenging, particularly in high-speed assembly line production operations.

Similarly, if accurate yields are to be measured, multiple people are typically engaged in the weighing process. For example, one employee places an item (e.g., chicken body, fat, wing, leg, tender, breast) onto a scale, and another identifies the chicken part and estimates the scale stability by pressing the button. Rapidly weighing the chicken parts and correctly associating an accurate weight for each part is also challenging for workers.

### SUMMARY OF THE INVENTION

The invention relates to a smart-automated poultry plant system and process based on machine learning and computer vision. The smart-automated system and process predict the quality of poultry (e.g., chicken broilers) carcasses and analyze them for any imperfections resulting from production and transport welfare issues, as well as processing plant stunner, scalder, picker, and equipment malfunctions. Depending on the carcass detection result, the system and process can designate the carcass to stay in the processing line or to be redirected if any rework is necessary based on the automated visual examination at the first critical control point.

Accordingly, it is an object of this invention to provide a new and improved system and process for identifying imperfections in chickens and accurately weighing chickens and chicken parts during processing.

Another object of this invention is to provide automated computer vision-based smart chicken plant systems and processes to automize data collection and implement vision-based smart technology that is more versatile, economical, and inclusive than current technology and methodologies.

A further object of this invention is to provide smart-automated poultry plant systems and processes that use machine learning and computer vision for detecting, segmenting, and classifying the quality of poultry carcasses.

### BRIEF DESCRIPTION OF THE DRAWINGS

The above and other objects and advantages of this invention may be more clearly seen when viewed in conjunction with the accompanying drawing wherein:

FIG. 1 depicts an example of a system configured to detect defects in processed poultry carcasses in accordance with an illustrative embodiment of the invention disclosed herein.

FIG. 2 depicts an example of the defect detection and classification functionality of the system in accordance with an illustrative embodiment of the invention disclosed herein.

FIG. 3 depicts a flow chart of an example of an end-to-end transformer-based framework for simultaneous detection, segmentation, and classification of broiler chicken carcass defects in accordance with an illustrative embodiment of the invention disclosed herein.

FIG. 4 depicts a flow chart of an example of binary masking pre-processing steps in accordance with an illustrative embodiment of the invention disclosed herein.

FIG. 5 depicts a flow chart for creating a synthetic dataset with multiple broiler chicken carcasses.

FIG. 6 depicts a qualitative comparison of a single carcass dataset of an illustrative embodiment of the invention disclosed herein and Maskrcnn.

FIG. 7 depicts a qualitative comparison of synthetic multiple carcasses dataset of an illustrative embodiment of the invention disclosed herein and Maskrcnn.

FIG. 8 depicts an example of the system configured to identify and weigh the broiler carcass and broiler fat in accordance with an illustrative embodiment of the invention disclosed herein.

FIG. 9 depicts an example of the system configured to identify and weigh specific parts of the processed broiler in accordance with an illustrative embodiment of the invention disclosed herein.

### DETAILED DESCRIPTION OF THE INVENTION

While this invention is susceptible to embodiment in many different forms, there are shown in the drawings and will herein be described hereinafter in detail some specific embodiments of the invention. It should be understood, however, that the present disclosure is to be considered an exemplification of the principles of the invention and is not intended to limit the invention to the specific embodiments so described.

The invention relates to systems and processes for implementing computer vision and machine learning in a poultry processing plant. The invention can also be applied to other meat processing facilities and similar assembly or disassembly systems. Visual inspection is one of the most basic but essential steps in controlling meat quality before the product is prepared, packaged, and distributed to the market. The smart-automated systems and processes that are disclosed herein improve poultry processing and food safety by using an automated detection model to classify normal or defective (contaminated, mutilated, or skin lacerated) carcasses.

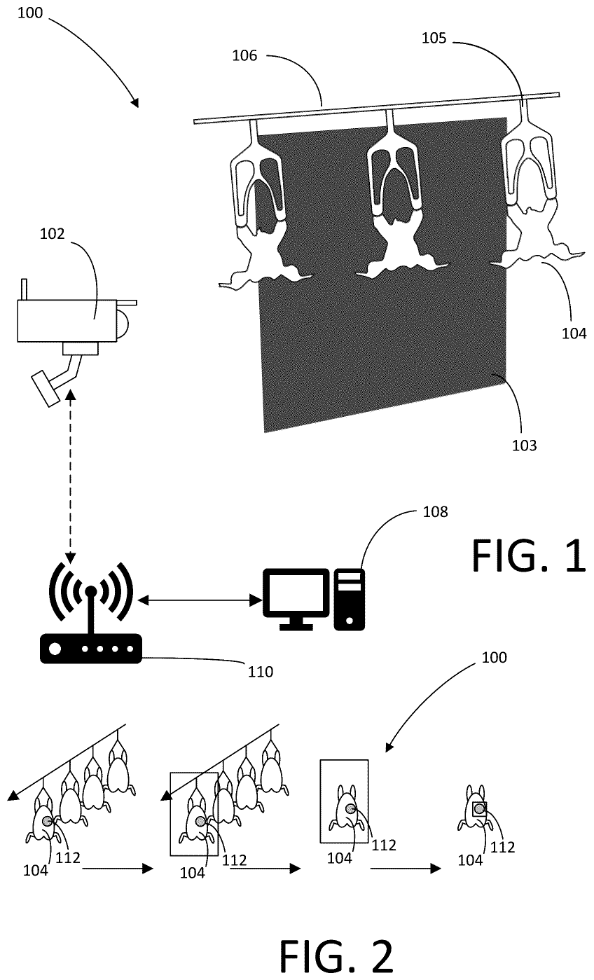

Referring to the drawings in detail, FIG. 1 illustrates a system 100 that generally includes one or more cameras 102, which are configured to obtain digital images, still frames, and/or video images of one or more poultry carcasses 104 moved by a conveyor to automatically determine if the processed poultry 104 has any defects. The camera 102 is placed adjacent to the carcasses 104 moving along a processing line 106 to detect imperfections. If the system 100 is utilized with video images of poultry carcasses 104, video frames can be extracted and processed as provided herein. Preferably, the images are high-definition digital images (e.g., 24 MB digital images), but other arrangements are possible (e.g., 4k or higher video images). The camera 102 can be configured to record and output color and depth (i.e., RGB-D) images in digital formats. The images are directed to a computer system 108 through a data network 110. It will be appreciated that the computer system 108 may include a single computer or a plurality of interconnected computers that reside in local and remote locations. It will be further appreciated that the post-acquisition analysis of image data obtained from the cameras 102 will be carried out with computer-implemented instructions stored and executed within the computer system 108.

Turning to FIG. 2, the system 100 is configured to detect and recognize each processed carcass 104 from other objects captured by the camera 102. The system 100 detects, analyzes, and segments the shape of the carcass 104 after scalding, picking, and removal of head and feet in the processing plant and measures for any remaining feathers or other carcass issues. Once each poultry carcass 104 has been detected, as indicated by a bounding box around each poultry 104, the system 100 uses advanced machine learning (e.g., deep neural networks) to identify any defects 112 or other visual abnormalities in the processed poultry 104. If the system 100 identifies a defect 112, as depicted in FIG. 2, the system 100 directs the defective processed chicken 104 to a reworking line, where the artifacts or defects (e.g., feathers, bruising, etc.) can be remedied or the defective processed poultry 104 can be discarded. Once the system 100 has identified a defect 112, the system 100 tracks the defective processed poultry 104 until the defect 112 is remedied or the carcass is discarded. If system 100 does not identify a defect in the poultry carcass 104, the poultry carcass 104 is passed for subsequent downstream processing.

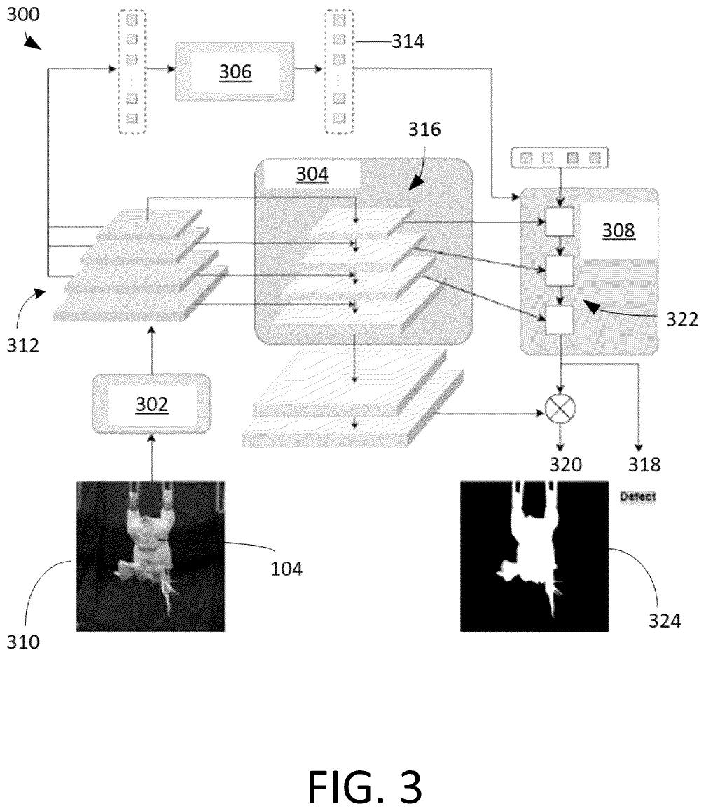

FIG. 3 depicts a flow chart of an example of an end-to-end transformer-based framework 300 for simultaneous detection, segmentation, and classification of the poultry carcass 104 defects. As illustrated, the end-to-end transformer-based framework 300 includes four (4) main process modules: a backbone or image input module 302, a pixel decoder module 304, a multi-scale transformer encoder 306, and a mask-attention transformer decoder module 308. The backbone 302 takes an input image 310 and creates a set of four low feature maps 312. The first three (3) feature maps 312 are used by the multi-scale transformer encoder 306 to generate a set of feature maps 314. The pixel decoder 304 takes the output of the backbone 302 to generate a pyramid network of feature maps 316, and the first three (3) feature maps 316 are fed successively to the mask-attention transformer decoder 308 along with the feature maps 314 of the multi-scale transformer encoder 306. The output of the mask-attention transformer decoder 308 goes through a linear classifier 318 to get a class prediction. The last feature map 316 from the pixel decoder 304 is up-sampled two (2) times before doing dot product with the output of the transformer decoder 306 to generate a prediction mask 320.

The backbone or image input module 302 of the system 100 is a convolutional neural network (CNN) network that takes an input image 310 with a size of H×W and generates a set of four low-resolution feature maps 312:

$$\{ {F}_{1} ∈ {ℝ}^{{C}_{{F}_{1}} \times \frac{H}{4} \times \frac{W}{4}} , {F}_{2} ∈ {ℝ}^{{C}_{{F}_{2}} \times \frac{H}{8} \times \frac{W}{8}} , \\ {F}_{3} ∈ {ℝ}^{{C}_{{F}_{3}} \times \frac{H}{16} \times \frac{W}{16}} , {F}_{4} ∈ {ℝ}^{{C}_{{F}_{4}} \times \frac{H}{32} \times \frac{W}{32}} \} \qquad Equation 1$$

where C_{F1}, C_{F2}, C_{F3}, C_{F4} are the number of channels.

The pixel decoder module 304 of the system 100 generates features from the backbone 302 to produce the pyramid of feature maps 316 with resolutions of 1/32, 1/16, ⅛, and ¼ of the input image 310 so that both high and low resolutions can be utilized. To get the first feature map 316, the pixel decoder 304 takes F₄ and performs 1×1 convolution (to decrease channel size to Cₚ). This first feature map 316 is upsampled by a factor of 2 and then merged with the corresponding feature with the same spatial sizes, i.e., F₃, by element-wise summation. A 3×3 convolution is then followed on the merged map to get a final feature map 316. This procedure is repeated until the highest resolution feature map 316, and the pixel decoder module 304 has produced the feature pyramid network (FPN) with at least four feature maps 316:

$$\{ {D}_{1} ∈ {ℝ}^{{C}_{p} \times \frac{H}{4} \times \frac{W}{4}} , {D}_{2} ∈ {ℝ}^{{C}_{p} \times \frac{H}{8} \times \frac{W}{8}} , \\ {D}_{3} ∈ {ℝ}^{{C}_{p} \times \frac{H}{16} \times \frac{W}{16}} , {D}_{4} ∈ {ℝ}^{{C}_{p} \times \frac{H}{32} \times \frac{W}{32}} \} \qquad Equation 2$$

The multi-scale transformer encoder module 306 of the system 100 inputs the three first feature maps 312 from the backbone 302 from low to high resolution, i.e., F₄, F₃, and F₂, followed by a 1×1 convolution to get the same channel size Ce. Each feature map 312 is added a positional embedding eₚₒₛᵢₜᵢₒₙ∈ [symbol] ^{H}^{ₗ}^{W}^{ₗ}^{×C}^{ₑ} and a scale-level embedding eₗₑᵥₑₗ∈ [symbol] ^{1×C}^{ₑ} for determining to which feature level each pixel belongs. The features are then flattened, resulting in three (3) feature maps 314 having a size of HₗWₗ×Cₑ, where HₗWₗ are the spatial resolution of features at the corresponding l-th layer. The concatenated feature of three (3) scale feature maps 314 are passed as input to the transformer encoder module 308. The transformer encoder module 308 includes a multi-scale deformable attention submodule and a feed-forward network (FFN). The output of the transformer encoder module 308 is three (3) scale feature maps 314 with the identical sizes of the input image 310.

The input of the mask-attention transformer decoder module 308 are the scale feature maps 314 from the transformer encoder module 306 and N learnable positional embeddings acted as object queries. The decoder module 308 has three layers 322 and two (2) types of attention submodules in each layer: a mask-attention submodule 320 and a self-attention submodule 318. Object queries interact with one another in the self-attention submodule 318 to identify their relationships. Both the query and the key queries are object queries. The mask-attention submodule 320, for each query, extracts features by restricting cross-attention to the foreground region of the predicted mask. The query components are from the object queries, while the key elements are from the feature maps 314 from the transformer encoder 306. The mask-attention submodule 320 calculates the attention matrix via:

$${A}_{l} = softmax ( {Mask}_{l - 1} + {Query}_{l} {Key}_{l}^{T} ) {Value}_{l} + {A}_{l - 1} \qquad Equation 3$$

While attention mask Maskₗ₋₁ at pixel (x,y) defines as:

$${Mask}_{l - 1} ( x , y ) = \{ \begin{matrix}0 if {B}_{l - 1} ( x , y ) = 1 \\ - ∞ otherwise\end{matrix} \qquad Equation 4$$

Where Aₗ∈R^{N×C} is N query features at l-th layer, Bₗ₋₁ with size of N×HₗWₗ is the binarized output of the preceding (l₁)-th decoder layer's resized mask prediction. A₀ is denoted as input query features. B₀ is obtained from A₀. Using the three first features from the lowest resolution generated by the pixel decoder module 304, i.e., D₄, D₃ and D₂. Each feature is added a positional embedding eₚₒₛᵢₜᵢₒₙ∈ [symbol] ^{H}^{ₗ}^{W}^{ₗ}^{×C}^{_{d}} and a scale-level embedding eₗₑᵥₑₗ∈ [symbol] ^{1×C}^{_{d}}, in this case C_{d}=Cₑ. Those features from lowest to highest resolution are fed successively to the corresponding decoder 308 layer in a around-robin fashion. This three (3) layer decoder 308 is repeated D times. Therefore, the decoder module 308 has 3×D layers. The output of transformer decoder module 308 is a set of N per-segment embeddings 324 with the information of each segment the transformer 308 predicts.

A linear classifier with softmax activation can then be applied to generate N class prediction for each segment. To predict the mask, a two-layer multi-layer perceptron transforms N per-segment embeddings to N mask embeddings eₘₐₛₖ∈Cₑ×N. To further increase the detail of the mask prediction, the last pyramid feature from the pixel decoder 304 with a resolution ¼ the size of the original image and upsampled two times to get per-pixel embeddings eₚᵢₓₑₗ∈Cₑ×H×W before doing dot product with the mask embeddings eₘₐₛₖ from the transformer decoder module 308. A sigmoid activation can follow the dot product to help obtain N mask predictions.

### EXAMPLES

The systems and processes for implementing computer vision and machine learning in a poultry processing plant are further illustrated by the following examples, which are provided for the purpose of demonstration rather than limitation.

Camera equipment 102 to collect the photographs and videos, as shown in FIG. 2, was set up in a part of a processing plant where chicken carcasses 104 were hung on shackles 105 after feather removal. The cameras 102 were placed level with the carcasses 104, and a black curtain 103 was placed behind the conveyor belt 106 transporting the carcasses 104. FIG. 3 illustrates the pre-processing procedure 400 utilized in the study. If video was collected by the cameras 102, the system 100 analyzed the videos frame by frame. For each image, the system 100 cropped the image to the region of interest (ROI) (step 402), namely the broiler carcass 104 and the shackles 105. The dark color of the curtain 103 provided a contrast against the poultry carcass 104 under the facility lights and allowed the entire carcass 104 to be in the resulting photos. The pre-processing procedure 400 was done in grayscale, and the lighting caused slight shadows on the bottom half of the poultry. In order to calibrate the proper threshold, we divided the ROI in half where the lighting changes to produce the most accurate masks (step 404).

To further improve mask quality, the pre-processing procedure 400 performs binary thresholding on all three red-green-blue (RGB) channels to capture all needed information (step 408). By choosing thresholding numbers t for each image, the thresholded images by threshold function f_{threshold} can be calculated as:

$${f}_{threshold} ( x ) = \{ \begin{matrix}1 & if x \geq t \\ 0 & otherwise\end{matrix} \qquad Equation 5$$

and then combines all of them together for the final mask (step 410). Any remaining undesirable spots from thresholding are cleaned by using opening morphological transformations (step 412). The final step of the pre-processing procedure 40 was computing the area of any remaining contours and getting rid of any excess contours so only the main object remains (step 414). This step 414 results in a set of RGB images and corresponding mask annotation images.

Each video is a compilation of many continuous frames, so even just one singular broiler has an excess of corresponding image frames. For more straightforward labeling of the images, the system 100 automatically counted the birds, which also helped track which bird was connected to which image. This counting algorithm, shown in Algorithm 1 below, helped to more accurately note if the poultry was defective or normal while watching the index of carcasses.

Algorithm 1 Counting the carcases

```
for each frame do
  preprocessing
  FLAG ← False
  COUNT ← 0
  if the mask is within the ROI without touching the side then
    if FLAG == False then
      FLAG ← True
      increase COUNT
    end if
  else
    if FLAG == True then
      FLAG ← False
    end if
  end if
end for
```

### Algorithm 1

After the pre-processing procedure 400, the poultry carcass 104 must meet the criteria and be within the ROI without any excess pieces touching the border, i.e., x_{border}_{ₘᵢₙ}<xₘₐₛₖ_{ₘᵢₙ}<xₘₐₛₖ_{ₘₐₓ}<x_{border}_{ₘₐₓ}. A flag variable was used to know when to update the counting variable. Then, the process shown in Algorithm 2 converted the image sets to a computer vision format, COCO. The system 100 was set up with one directory that contained sets of images and one annotation file, including data such as the bounding box and the label of segmentation in the form of the polygon. The annotation file contained all the information for each image in the dataset.

Algorithm 2 Creating COCO format json

```
for each frame do
  filter for associated mask annotation
  Check if the name is in normal or defect
  Convert the mask to polygon array
  Save the annotations to json file
end for
```

### Algorithm 2

Table 1 below shows the number of segments in the dataset. Since there is only one carcass per image, the number of segments equals the number of images.

TABLE 1
Single dataset statistic

| | Normal | Defect | Total |
|---|---|---|---|
| Train | 1302 | 1715 | 3017 |
| Validation | 355 | 399 | 754 |
| Test | 320 | 188 | 508 |
| Total | | | 4279 |

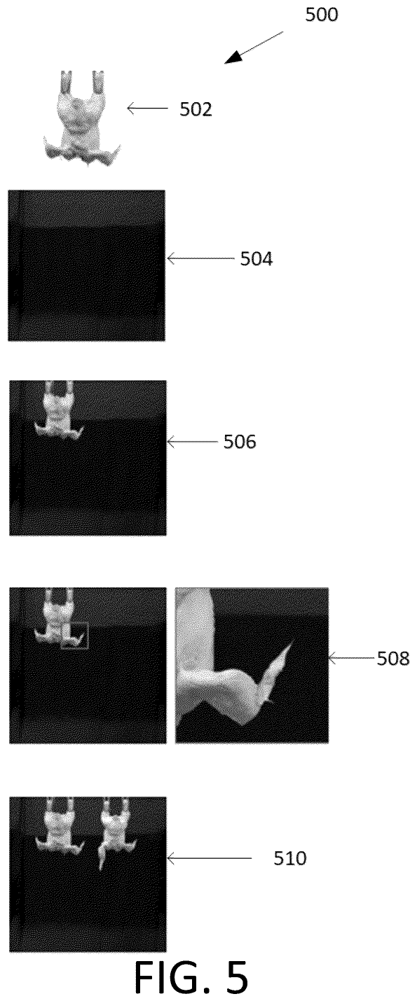

FIG. 5 shows a flowchart to create synthetic multiple chicken dataset 500. A black background was created and used as the template for the bird (step 504). For each annotation file, the broiler was cropped using the polygon from the annotation (step 502) and pasted on the template background (step 506). Gaussian blur was used on the edges of the images to make them look more realistic (step 508). The blur was used because the deep learning model could be overfitting due to the high contrast if the objects and the background were not blended. Another broiler chicken carcass was selected, cropped out like the first carcass, and then pasted randomly to the left or right (step 506). Once all the steps 500 were completed, the system cropped, pasted, and blurred again for the second broiler carcass. If the mask polygons overlap, the union polygon was subtracted from the mask polygons of the first carcass before saving the annotations. Table 2 shows the detailed number of segments in the dataset.

TABLE 2
Synthetic multiple dataset statistic

| | Normal | Defect | Total |
|---|---|---|---|
| Train | 1571 | 1842 | 3413 |
| Validation | 422 | 466 | 888 |
| Test | 359 | 267 | 626 |
| Total | | | 4279 |

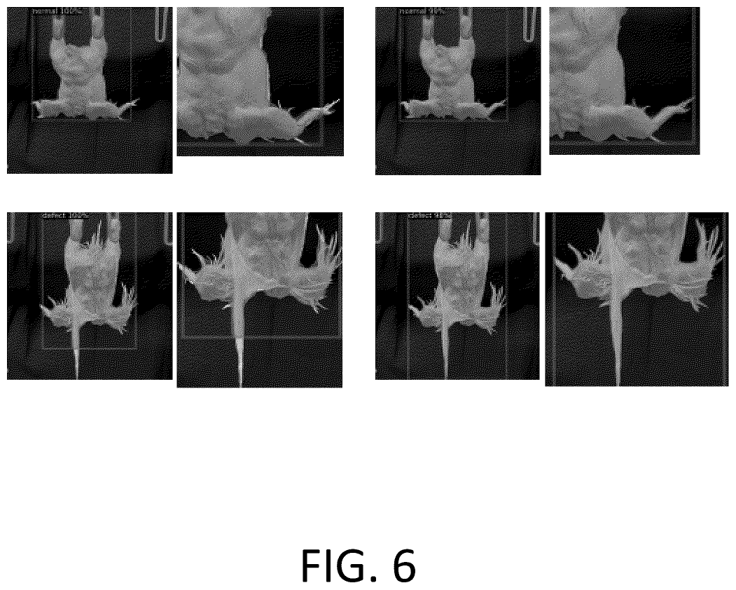

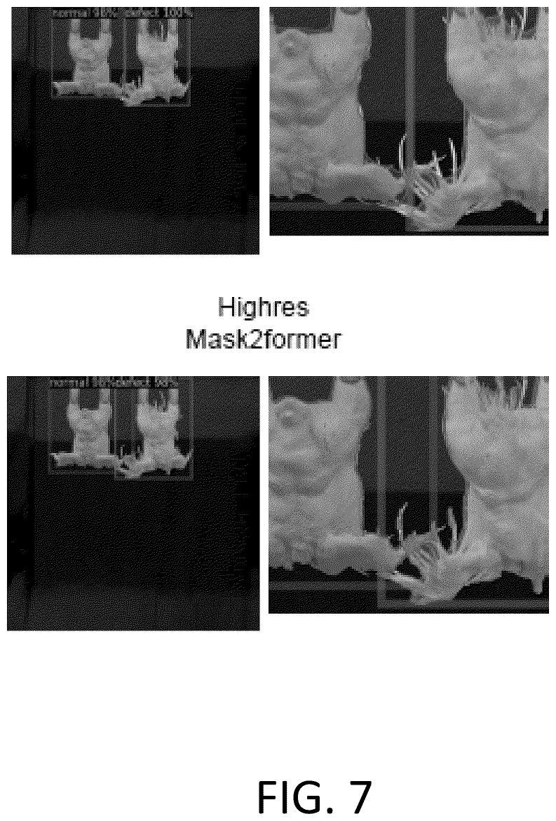

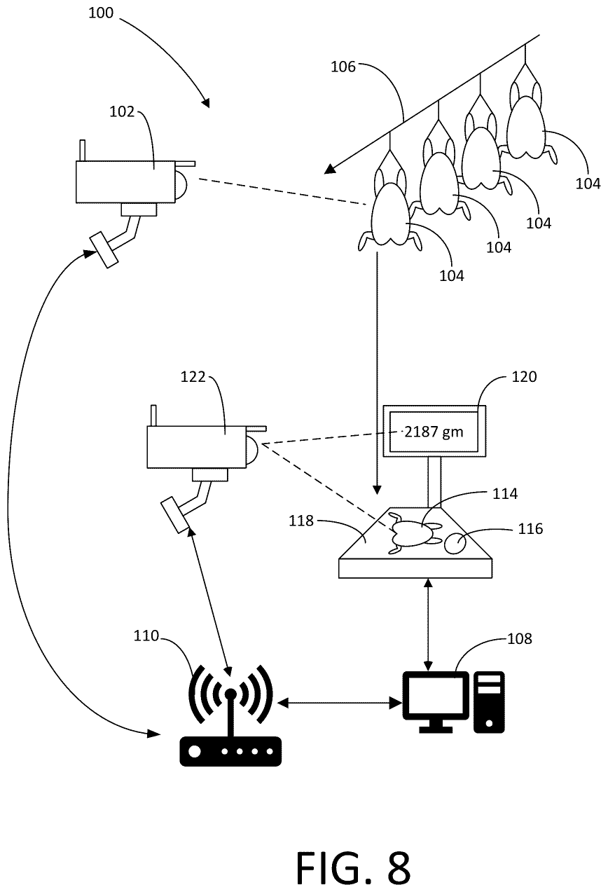

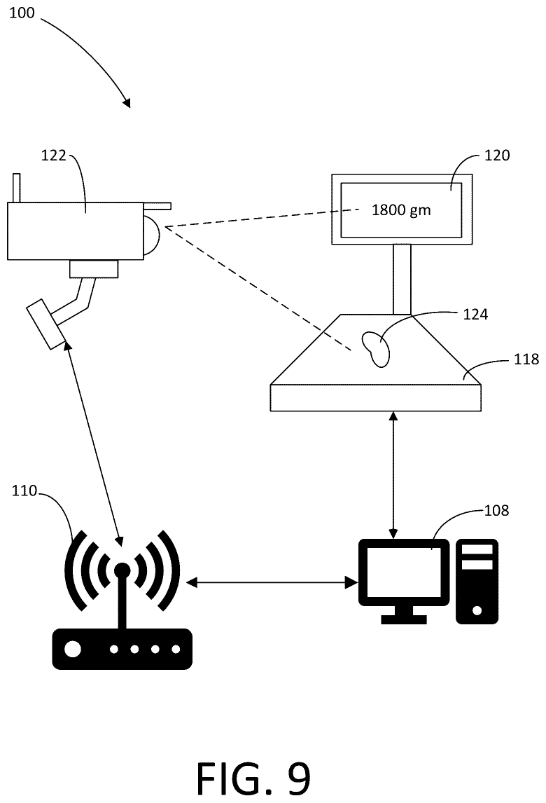

The system 100 was compared with Mascrnn, a network instance segmentation, for a baseline for validation and to produce the single dataset in Table 1 and the synthetic dataset in Table 2. Input resolutions were both resized to 256×256, and AP@95 was used as the default metric for instance segmentation. FLOPs are calculated over 100 images in the test set of each dataset. When computing frames-per-second (fps), the average runtime on a single NVIDIA RTX A6000 GPU with a batch size of 1 for the complete test set was used. The system 100 was demonstrated to have better AP on both datasets than Maskrcnn with all backbone for a large margin. Maskrcnn models can not perform detection at IoU=95 while the system 100 still provided reasonable AP scores, indicating that the system 100 can provide high-resolution masks. FIGS. 5 and 6 show the qualitative results of the system 100 and Maskrcnn on R50 backbone on the test set. The system 100 provided better mask detection, not just in shape but also in fine details on the birds, which will help to perform other tasks later, i.e., estimate sizes and localize the defects.

In another aspect, the system and process 100 are configured to analyze images of processed poultry carcass parts being weighed on a scale. In this mode of operation, the system and process are configured to automatically classify the processed poultry carcass parts being weighed. The system and process also confirm the weight displayed for the processed poultry part by conducting a time series analysis of the weight displayed on the scale for the processed poultry part with the weight directly output by the scale to the computer system.

Turning now to FIG. 3, shown therein is a depiction of the automated broiler processing system 100 configured to discriminate between a chicken carcass 114 and the abdominal fat pad 116 that has been removed from the chicken carcass 114. In this embodiment, the automated broiler processing system 100 also includes an electronic (digital) scale 118, a scale display 120, and scale cameras 122. The automated broiler processing system 100 can be trained first localize the scale 118 in the video feed provided by the scale cameras 122, and then detect if a chicken carcass 114 or fat pad 116 is on the scale 118. The automated broiler processing system 100 can then distinguish between an image of the chicken carcass 114, an image of the abdominal fat pad 116, or the presence of both the chicken carcass 114 and abdominal fat pad 116 on the scale 118 (as depicted in FIG. 3). In this mode of operation, the scale cameras 122 of the automated broiler processing system 100 are focused on the scale 118 and display 120. The scale 118 is connected directly or indirectly to the computer system 108. The scale cameras 122 are installed at the scale 118 and the computer system 108 of the automated broiler processing system 100 is trained to distinguish between the chicken carcass 114 and the abdominal fat pad 116. In addition to distinguishing between the chicken carcass 114 and the abdominal fat pad 116, the computer system 108 is also configured to read the output on the display 120 of the scale 118.

To carry out this functionality, the computer system 108 of the automated broiler processing system 100 first detects the scale 118 and display screen 120 to recognize if the scale 118 is vacant, or if a carcass 114 or fat pad 116 has been deposited on the scale 118. Once the computer system 108 detects the presence of an object of interest (either the chicken carcass 114 or the abdominal fat pad 116), the automated broiler processing system 100 incorporates a recognizer module to identify if the object on the scale 118 is a chicken carcass 114, the abdominal fat pad 116, or both. At the same time, a digit detector module and a digit recognizer module within the computer system 108 of the automated broiler processing system 100 are configured to read the digits from the display 120 on the scale 118, and associate that reading with a specific time series analysis to correlate the reading from the display 120 with the reading that is transmitted directly from the scale 118 to the computer system 108. Both the digit recognizer module and time series analysis are used to estimate the most stable weight on the scale 118. The computer system 108 also includes an action recognizer to identify if a carcass 114 or fat pad 116 is placed on the scale 118. This allows the automated broiler processing system 100 to track the same carcass 114 and fat pad 116 throughout the processing system.

Furthermore, the digit recognizer module of the automated broiler processing system 100 contains five sub-modules as follows: (i) digital scale detection to localize the scale; (ii) digital scale registration to align the scale by computing a homography matrix: (iii) digits separation to partition a sequence of digits on the scale screen into a set of individual digits; (iv) image enhancement and denoising by generative adversarial networks (GANs); and (v) digit classification by an advanced machine learning technique, e.g., Deep Learning with Convolutional Neural Network (CNN) where 12 classes are defined as the last fully connected layer.

Thus, in this mode of operation, the automated broiler processing system 100 is configured to: (i) automatically discriminate between a chicken carcass 114 and an abdominal fat pad 116 on the scale 118; (ii) confirm the most stable weight for the object on the scale 118; and (iii) identify the weight of the carcass 114 and fat pad 116 from the same chicken 104; and (iv) input into the computer system 108 the type of product (i.e., chicken carcass 114 or abdominal fat pad 116) and the weight of the product by using visual confirmation of the scale measurements sent directly to the computer system 108.

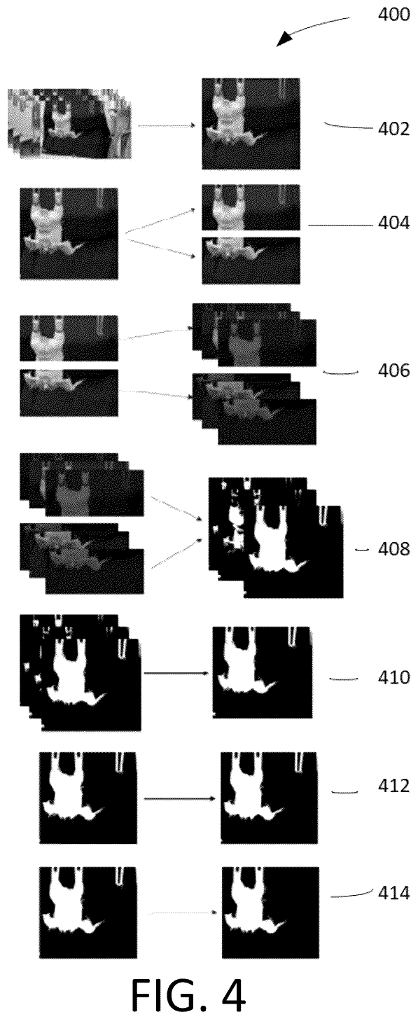

Turning to FIG. 4, shown therein is a depiction of yet another mode of operation for the automated broiler processing system 100. In this mode of operation, the computer system 108 of the automated broiler processing system 100 is configured to automatically detect the identity of a specific chicken part 122 (e.g., breast fillets and tenders, wings, thighs, and drumsticks) and automatically enter the weight of the identified part into the computer system 108.

To measure the weight of carcass parts 124 (i.e., breast fillets, breast tenders, thighs, drumsticks, wings, and other parts), the automated broiler processing system 100 is configured to monitor the carcass parts 124 as they are automatically placed on the scale 118. The scale camera 122 is installed at the scale 118 to identify the carcass parts 124 on the scale 118, and capture the corresponding weight at the scale display 120. The computer system 108 of the automated broiler processing system 100 includes a carcass parts recognizer module to distinguish between different parts of the chicken 104 at the scale 118. Notably, this carcass part recognizer also includes token identification. In this mode of operation, the computer system 108 of the automated broiler processing system 100 also contains a digit recognizer focused on the display 120 of the scale 118 to read the digits, execute a machine learning algorithm to estimate the stability of the visual signal from the scale base 118, and perform a time series analysis. Both the digit recognizer module and time series analysis are used to estimate the most stable weight for the item on the scale 118.

As noted above, the system and process may be implemented in a computer system using hardware, software, firmware, tangible computer-readable media having instructions stored thereon, or a combination thereof and may be implemented in one or more computer systems or other processing systems.

If programmable logic is used, such logic may execute on a commercially available processing platform or a special purpose device. One of ordinary skill in the art may appreciate that embodiments of the disclosed subject matter can be practiced with various computer system configurations, including multi-core multi-processor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the inventions may be implemented in terms of this example computer system. After reading this description, it will become apparent to a person skilled in the relevant art how to implement one or more of the inventions using other computer systems and/or computer architectures. Although operations may be described as a sequential process, some of the operations may be performed in parallel, concurrently, and/or in a distributed environment and with program code stored locally or remotely for access by single or multi-processor machines. In addition, in some embodiments, the order of operations may be rearranged without departing from the spirit of the disclosed subject matter.

The processor device may be a special purpose or a general-purpose processor device or maybe a cloud service wherein the processor device may reside in the cloud. As will be appreciated by persons skilled in the relevant art, the processor device may also be a single processor in a multi-core/multi-processor system, such system operating alone or in a cluster of computing devices operating in a cluster or server farm. The processor device is connected to a communication infrastructure, for example, a bus, message queue, network, or multi-core message-passing scheme.

The computer system also includes a main memory, for example, random access memory (RAM), and may also include a secondary memory. The secondary memory may include, for example, a hard disk drive or a removable storage drive. The removable storage drive may include a floppy disk drive, a magnetic tape drive, an optical disk drive, a flash memory, a Universal Serial Bus (USB) drive, or the like. The removable storage drive reads from and/or writes to a removable storage unit in a well-known manner. The removable storage unit may include a floppy disk, magnetic tape, optical disk, etc., which is read by and written to by the removable storage drive. As will be appreciated by persons skilled in the relevant art, the removable storage unit includes a computer usable storage medium having stored therein computer software and/or data.

The computer system (optionally) includes a display interface (which can include input and output devices such as keyboards, mice, etc.) that forwards graphics, text, and other data from communication infrastructure (or from a frame buffer not shown) for display on a display unit.

In alternative implementations, the secondary memory may include other similar means for allowing computer programs or other instructions to be loaded into the computer system. Such means may include, for example, the removable storage unit and an interface. Examples of such means may include a program cartridge and cartridge interface (such as that found in video game devices), a removable memory chip (such as an EPROM, PROM, or Flash memory) and associated socket, and other removable storage units and interfaces which allow software and data to be transferred from the removable storage unit to computer system.

The computer system may also include a communication interface. The communication interface allows software and data to be transferred between the computer system and external devices. The communication interface may include a modem, a network interface (such as an Ethernet card), a communication port, a PCMCIA slot, and card, or the like. Software and data transferred via the communication interface may be in the form of signals, which may be electronic, electromagnetic, optical, or other signals capable of being received by the communication interface. These signals may be provided to the communication interface via a communication path. Communication path carries signals, such as over a network in a distributed computing environment, for example, an intranet or the Internet, and may be implemented using wire or cable, fiber optics, a phone line, a cellular phone link, an RF link, or other communication channels.

In this document, the terms “computer program medium” and “computer usable medium” are used to generally refer to media such as removable storage unit, removable storage unit, and a hard disk installed in the hard disk drive. The computer program medium and computer usable medium may also refer to memories, such as main memory and secondary memory, which may be memory semiconductors (e.g., DRAMs, etc.) or cloud computing.

Computer programs (also called computer control logic) are stored in the main memory and/or the secondary memory. The computer programs may also be received via the communication interface. Such computer programs, when executed, enable the computer system to implement the embodiments as discussed herein, including but not limited to machine learning and advanced artificial intelligence. In particular, the computer programs, when executed, enable the processor device to implement the processes of the embodiments discussed here. Accordingly, such computer programs represent controllers of the computer system. Where the embodiments are implemented using software, the software may be stored in a computer program product and loaded into the computer system using the removable storage drive, the interface, the hard disk drive, or the communication interface.

Moreover, embodiments of the disclosure may be practiced with other computer system configurations, including hand-held devices, multi-processor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Embodiments of the inventions also may be directed to computer program products comprising software stored on any computer useable medium. Such software, when executed in one or more data processing devices, causes a data processing device(s) to operate as described herein. Embodiments of the inventions may employ any computer-useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The benefits and advantages described above may relate to one embodiment or may relate to several embodiments. The embodiments are not limited to those that solve any or all of the stated problems or those that have any or all of the stated benefits and advantages. The operations of the methods described herein may be carried out in any suitable order or simultaneously where appropriate. Additionally, individual blocks may be added or deleted from any of the methods without departing from the spirit and scope of the subject matter described herein. Aspects of any of the examples described above may be combined with aspects of any of the other examples described to form further examples without losing the effect sought.

The above description is given by way of example only, and various modifications may be made by those skilled in the art. The above specification, examples, and data provide a complete description of the structure and use of exemplary embodiments. Although various embodiments have been described above with a certain degree of particularity or with reference to one or more individual embodiments, those skilled in the art could make numerous alterations to the disclosed embodiments without departing from the spirit or scope of this specification.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Thus, the preceding detailed description is presented for purposes of illustration only and not of limitation, and the scope of the invention is defined by the preceding description and with respect to the attached claims.

What is claimed is:

1. A computer vision process for detecting broiler chicken carcass defects from a video source, the process comprising the steps of electronically:
i. acquiring one or more sets of frames or images from the video source of a plurality of broiler chicken carcasses after scalding, picking, and removal of head and feet in a processing plant;
ii. automatically identifying one or more of the carcasses in the frames or images;
iii. detecting a potential defect or visual abnormality of one or more of the identified carcasses from the images;
iv. if a potential defect is detected in step iii, routing the identified carcass to a reworking or discard operation.

2. The process of claim 1 wherein step i. further comprises the step of:
i. acquiring one or more sets of frames or images of the plurality of broiler chicken carcasses against a dark color background.

3. The process of claim 2 wherein step ii. further comprises the step of:
i. segmenting, cropping, or both the images to a region of interest; and
ii inserting a bounding box around each region of interest.

4. The process of claim 3 further comprises the steps of:
i. detecting, analyzing, and segmenting the shape of the carcass in the region of interest using a deep learning neural network; and
ii. optionally, measuring for any remaining feathers or other carcass issues of the carcass in the region of interest.

5. The process of claim 4 wherein step iii. further comprises the step of:
i. creating a set of low-resolution feature maps from the region of interest using a convolutional neural network;
ii. creating a feature pyramid network of the feature maps with varying resolutions;
iii. creating a concatenated feature of feature maps from the feature pyramid network; and
iv. creating scaled feature maps with identical sizes of the frames or images.

6. A system for detecting defects for broiler chicken carcasses, the system comprising:
one or more video sources;
a wireless interface;
a data store;
a processor communicatively coupled to the one or more video sources, the wireless interface, and the data store; and
memory storing instructions that, when executed, cause the processor to:
store, in the data store, one or more sets of frames or images from the video source of the broiler chickens on a processing line in a poultry processing plant;
identify, using the processor, one or more of the carcasses in the frames or images;
detecting, using the processor, a potential defect or visual abnormality of one or more of the identified carcasses from the images; and
routing the identified carcass to a reworking or discard operation if a potential defect is detected.

7. The system of claim 6, wherein the detected defects of the identified chickens are hosted on a cloud-based server and the detected defects of the identified chickens are provided through sending an email, website log in, or a link directed to the detected defects.

8. The system of claim 6, further comprises a deep learning neural network to detect, analyze, and segment the shape of the carcass in a region of interest in a bounding box inserted on the images.

9. The system of claim 6 wherein the instructions comprise a backbone or image input module, a pixel decoder module, a multi-scale transformer encoder, and a mask-attention transformer decoder module.

10. The system of claim 9, wherein the instructions, when executed, cause the processor to:
i. create a set of low-resolution feature maps from the region of interest using a convolutional neural network of the image input module;
ii. create a feature pyramid network of the feature maps with varying resolutions using the pixel decoder module;
iii. create a concatenated feature of feature maps from the feature pyramid network using the multi-scale transformer encoder; and
iv. create scaled feature maps with identical sizes of the frames or images using the mask-attention transformer decoder module.

11. A process for automatically weighing and classifying processed poultry parts with a computer system that receives images from a camera, the process comprising the steps of:
i. automatically placing the processed poultry parts on a scale that includes a display and a data connection with the computer system;
ii. obtaining images from a camera of the processed poultry parts on the scale;
iii. using a computer-implemented classifier module to automatically determine the identity of the processed poultry parts on the scale;
iv. obtaining images from the camera of the scale and the display on the scale;
v. using a computer-implemented digit recognizer module to determine the weight indicated on the scale while the processed poultry parts are on the scale; and
vi. applying a time series analysis to verify that a weight measurement output directly from the scale to the computer system matches the weight displayed on the scale while the classified poultry parts are being weighed.
